(19) United States
(12) Patent Application Publication
(10) Pub. No.: US 2017/0164041 A1
(43) Pub. Date: Jun. 8, 2017

(54) Method and electronic device for playing videos

(71) Applicants: Le Holdings (Beijing) Co., Ltd., Beijing (CN); LeCloud Computing Co., Ltd., Beijing (CN)

(72) Inventor: Kai Ping, Beijing (CN)

(21) Appl. No.: 15/246,562

(22) Filed: Aug. 25, 2016

Related U.S. Application Data
(63) Continuation of application No. PCT/CN2016/089467, filed on Jul. 8, 2016.

(30) Foreign Application Priority Data
Dec. 7, 2015 (CN) 201510888673.X

(51) Int. Cl. H04N 21/434; H04N 19/42; H04N 19/44; H04N 19/136

(52) U.S. Cl. CPC H04N 21/4347; H04N 19/136; H04N 19/42; H04N 19/44

(57) ABSTRACT

Disclosed are a method and an electronic device for playing videos. The method includes: obtaining data of multiple channels of videos which needs to be played currently; decoding the data of the multiple channels of videos by a hard decoding method; when receiving response information indicating that decoding of data of one or more of the multiple channels of videos fails, decoding the data of the one or more of channels of videos by a soft decoding method; and playing the decoded data of the multiple channels of videos.

### CROSS REFERENCE TO RELATED APPLICATIONS

This application is a continuation of International Application No. PCT/CN2016/089467, filed on Jul. 8, 2016, which is based upon and claims priority to Chinese Patent Application No. 201510888673.X, filed on Dec. 7, 2015, the entire contents of all of which are incorporated herein by reference.

### TECHNICAL FIELD

The present disclosure relates to video technologies, and more particularly, to a method and an electronic device for playing videos.

### BACKGROUND

Recently, more and more users select to view videos by accessing video networks with continuous developments of Internet technologies and increasingly richer network resources. When a user wants to view a live video via a network, he/she may use a video player to decode and play the video data. A soft decoding (software-based decoding) method or a hard decoding (hardware-based decoding) can be used to decode video data. The soft decoding method mainly uses software to decode video data, and most of the processing works are performed by a Central Processing Unit (CPU). And, in the hard decoding method, a core of a graphics card performs the decoding work, which can reduce the load of the CPU. During the playing of the video data, users sometimes want to play data of multiple channels of videos according to actual requirements. At this time, multiple video players can be used to play corresponding ones of the multiple channels of videos.

Currently, when data of multiple channels of videos are played concurrently, the data of all the channels of videos can be decoded using the soft decoding method to play the data of the multiple channels of videos currently. However, the playing effect obtained by the soft decoding method is relatively poor as compared with the hard decoding method, and the hardware resources of the CPU are consumed. Alternatively, according to performance parameters of different terminal devices, a threshold for the number of video players which support decoding and playing video data by the hard decoding method corresponding to different terminal devices are calculated in advance, and then according to the number threshold, data of the current multiple channels of videos are played by the hard coding method. However, sometimes the playing of the video data may fail. For example, if one terminal device can only support opening three video players concurrently to play video data by the hard decoding method, when data of five channels of videos needs to be played, the playing of the remaining two channels will fail.

### SUMMARY

The present disclosure provides a method and an electronic device for playing videos to solve the problem in prior arts that if data of all channels of videos are played by the soft decoding method, the playing effect of the videos may be influenced and CPU may bear a relatively high load, and if data of all channels of videos are played by the hard decoding method, the playing of the video data may fail.

In order to solve the above technical problem, according to a first aspect, embodiments of the present disclosure provide a method for playing videos, implemented by a terminal, including:

obtaining data of multiple channels of videos which needs to be played currently;

decoding the data of the multiple channels of videos by a hard decoding method;

when receiving response information indicating that decoding of data of one or more of the multiple channels of videos fails, decoding the data of the one or more of channels of videos by a soft decoding method; and

playing the decoded data of the multiple channels of videos.

In a second aspect, embodiments of the present disclosure provide a non-transitory computer-readable storage medium storing executable instructions, wherein the executable instructions are configured to perform any methods for playing videos mentioned by embodiments of the present disclosure.

In a third aspect, embodiments of the present disclosure provide an electronic device, including: at least one processor; and a memory communicably connected with the at least one processor for storing instructions executable by the at least one processor, wherein execution of the instructions by the at least one processor causes the at least one processor to perform any methods for playing videos mentioned by embodiments of the present disclosure.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a method for playing videos in accordance with some embodiments.

FIG. 2 is a flow chart of another method for playing videos in accordance with some embodiments.

FIG. 3 is a block diagram of a device for playing videos in accordance with some embodiments.

FIG. 4 is a block diagram of another device for playing videos in accordance with some embodiments.

FIG. 5 is a block diagram of an electronic device which is configured to perform the methods for playing videos in accordance with some embodiments.

### DETAILED DESCRIPTION

To make the objectives, technical solutions, and advantages of the embodiments of the present disclosure clearer, the following clearly and completely describes the technical solutions in the embodiments of the present disclosure with combination of the accompanying drawings in the embodiments of the present disclosure. Apparently, the described embodiments are some but not all of the embodiments of the present disclosure.

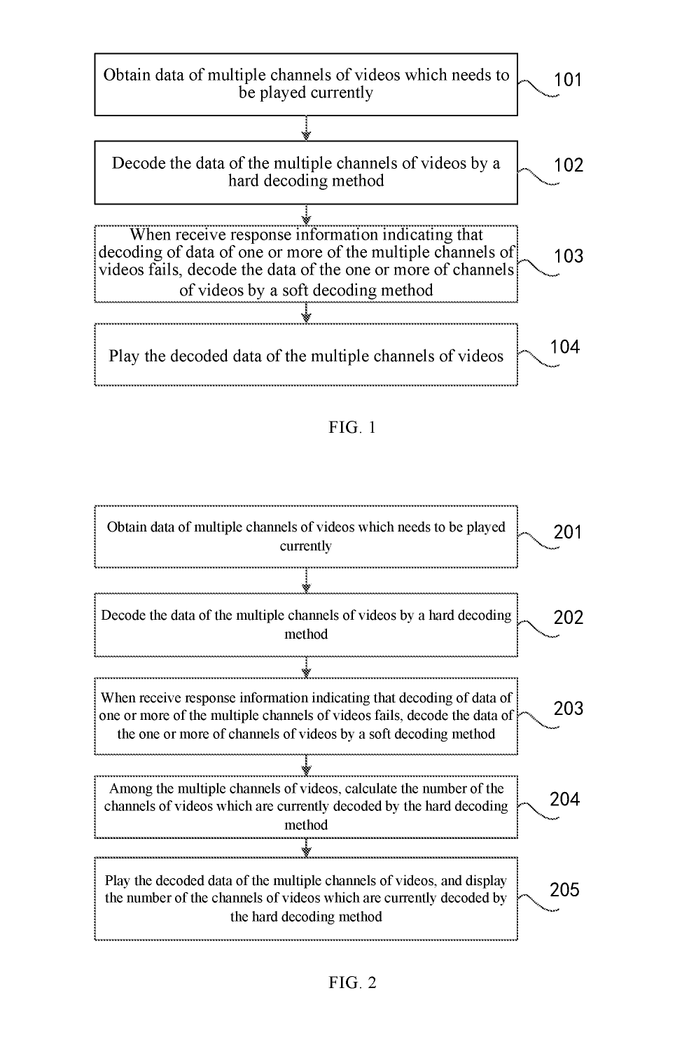

Embodiments of the present disclosure provide a method for playing videos. As shown in FIG. 1, the method can include the following steps.

In 101, data of multiple channels of videos which needs to be played currently is obtained.

In an embodiment of the present disclosure, the data of multiple channels of videos which needs to be played currently can be obtained from a video source server, or can be obtained locally. The specific obtaining methods can depend on actual situations, and embodiments of the present disclosure do not impose limitations on this.

In 102, the data of the multiple channels of videos is decoded by a hard decoding method.

In 103, when response information indicating that decoding of data of one or more of the multiple channels of videos fails is received, the data of the one or more of channels of videos is decoded by a soft decoding method.

In an embodiment of the present disclosure, multiple video players having the hard decoding function can be used to perform hard decoding on the data of the multiple channels of videos. When the response information indicating that decoding of data of one or more of the multiple channels of videos fails is received, i.e., the decoding of video data corresponding to one or more video players fails, a corresponding number of video players having the soft decoding function can be used to decode the data of the one or more channels of videos, decoding of which have failed.

In 104, the decoded data of the multiple channels of videos is played.

For example, when a terminal device needs to decode and play data of five channels of videos, the terminal device firstly uses five video players having the hard decoding function to decode and play the data of the five channels of videos. When decoding of the data of two channels of videos fails, the terminal device uses two video players having the soft decoding function to perform soft decoding on the video data, hard decoding of which have failed, so as to play the video data.

In the method for playing videos provided by embodiments of the present disclosure, after data of multiple channels of videos which needs to be played currently is obtained, the data of the multiple channels of videos is decoded by a hard decoding method firstly; when response information indicating that decoding of data of one or more of the multiple channels of videos fails is received, the data of the one or more of channels of videos is decoded by a soft decoding method. In this way, the decoding of the data of one or more channels of videos which cannot be decoded by the hard decoding method can be switched to the soft decoding method so as to play the video data. As compared with prior arts, the present disclosure can decode the data of multiple channels of videos by a combination of the hard decoding and the soft decoding, and thus the playing effect of videos can be improved and the load born by the CPU can be reduced. Also, when the decoding of the video data by the hard decoding method fails, the decoding of the video data can be automatically switched to the soft decoding to decode and play videos, and thus failures of playing of video data can be avoided. The present disclosure can decode and play video data using the hard decoding method as much as possible for different terminal devices.

Embodiments of the present disclosure provide another method for playing videos. As shown in FIG. 2, the method can include the following steps.

In 201, data of multiple channels of videos which needs to be played currently is obtained.

In an embodiment of the present disclosure, the data of multiple channels of videos which needs to be played currently can be obtained from a video source server, or can be obtained locally. The specific obtaining methods can depend on actual situations, and embodiments of the present disclosure do not impose limitations on this.

In 202, the data of the multiple channels of videos is decoded by a hard decoding method.

In an embodiment of the present disclosure, step 202 can include: by a preset hard decoding interface function, extracting the data of the multiple channels of videos into corresponding preset hard decoders to perform decoding. The preset hard decoding interface function can be configured according to users' actual requirements. The preset hard decoders are used to perform the hard decoding on the video data. The preset hard decoders can be configured in the video players.

In 203, when response information indicating that decoding of data of one or more of the multiple channels of videos fails is received, he data of the one or more of channels of videos is decoded by a soft decoding method.

In an embodiment of the present disclosure, the step 203 can include: when receiving the response information indicating that the decoding of the data of one or more of the multiple channels of videos fails, by a preset soft decoding interface function, extracting the data of the one or more channels of videos into corresponding preset soft decoders to perform decoding. The preset soft decoding interface function can be configured according to users' actual requirements. The preset soft decoders are used to perform the soft decoding on the video data.

Specifically, the data of each channel of video can be decoded and played by a preset video player. The preset video player can have two decoding functional modules configured therein, and the two decoding functional modules have a preset hard decoder and a preset soft decoder configured therein. When the preset video player needs to decode and play data of one channel of video, the preset hard decoding interface function can be called firstly to extract the data of the channel of video to the preset hard decoder to perform decoding. If the decoding succeeds, the data of the channel of video can be decoded and played by the hard decoding method. If the decoding fails, the data of the channel of video is extracted to the preset soft decoder to perform decoding, and thereby the data of the channel of video can be decoded and played by the soft decoding method. It should be noted that, in the method including steps 101 to 104, video players having different decoding functions are used to decode video data, while in the present embodiment, the preset video player is used to decode and play the data of the channel of video; since only one player needs to be called to decode and play the video data, repeated downloading and buffering of video data can be avoided, and thus the decoding and playing efficiency of the video data can be improved.

Further, after step 203, the method can further include: outputting notification information to indicate that the data of the one or more channels of videos are decoded by the soft decoding method. For example, the notification information may be text notification information, picture notification information, audio notification information, video notification information and the like. In the embodiment of the present disclosure, by outputting the notification information after step 203, users can have an idea that data of one or more channels of videos are being decoded by the soft decoding method, thereby resulting in better user experience.

In 204, among the multiple channels of videos, the number of the channels of videos which are currently decoded by the hard decoding method is calculated.

In 205, the decoded data of the multiple channels of videos is played, and the number of the channels of videos which are currently decoded by the hard decoding method.

In the embodiment of the present disclosure, by displaying the number of the channels of videos which are currently decoded by the hard decoding method while playing the decoded data of the multiple channels of videos, users can have a clear idea of the number of the channels of videos for which the hard decoding mode is started, and thus user experience can be improved.

Further, after step 205, the method can further include: when receiving an instruction from a user which instructs to switch the decoding of data of one channel of video, which is selected by the user from the one or more channels of videos which are currently decoded by the soft decoding method, from the soft decoding method to the hard decoding method, using the soft decoding method to decode and play data of one of the one or more channels of videos which are currently decoded by the hard decoding method, and using the hard decoding method to decode and play the data of the one channel of video which is selected by the user.

In the method for playing videos provided by embodiments of the present disclosure, after data of multiple channels of videos which needs to be played currently is obtained, the data of the multiple channels of videos is decoded by a hard decoding method firstly; when response information indicating that decoding of data of one or more of the multiple channels of videos fails is received, the data of the one or more of channels of videos is decoded by a soft decoding method. In this way, the decoding of the data of one or more channels of videos which cannot be decoded by the hard decoding method can be switched to the soft decoding method so as to play the video data. As compared with prior arts, the present disclosure can decode the data of multiple channels of videos by a combination of the hard decoding and the soft decoding, and thus the playing effect of videos can be improved and the load born by the CPU can be reduced. Also, when the decoding of the video data by the hard decoding method fails, the decoding of the video data can be automatically switched to the soft decoding to decode and play videos, and thus failures of playing of video data can be avoided. The present disclosure can decode and play video data using the hard decoding method as much as possible for different terminal devices.

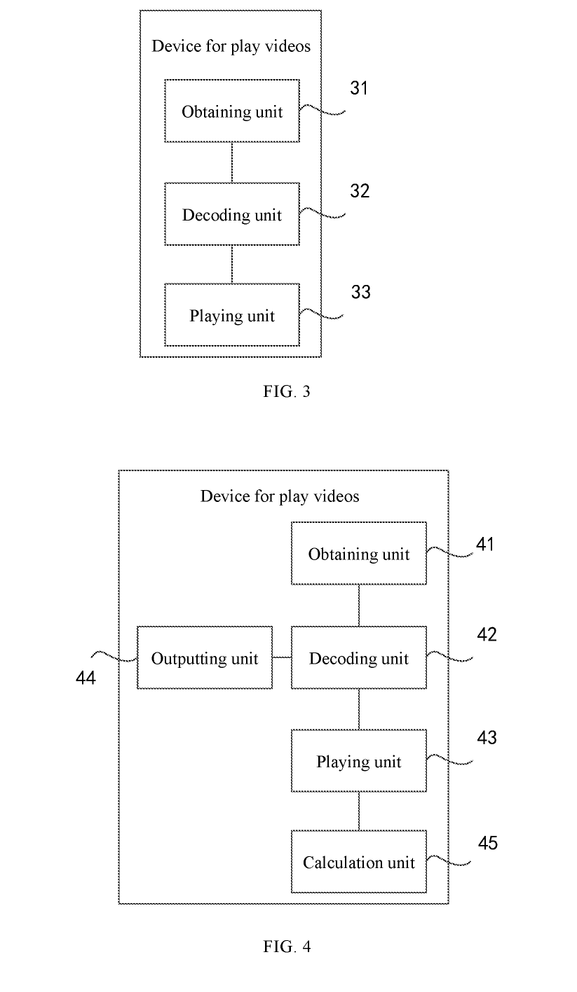

Further, embodiments of the present disclosure provide a device for playing videos to implement the method for playing videos described in connection with FIG. 1. As shown in FIG. 3, the device can include an obtaining unit 31, a decoding unit 32 and a playing unit 33.

The obtaining unit 31 can be configured to obtain data of multiple channels of videos which needs to be played currently. The obtaining unit 31 can obtain the data of multiple channels of videos from a video source server in which data of the multiple channels of videos which needs to be played currently are included.

The decoding unit 32 can be configured to decode the data of the multiple channels of videos obtained in the obtaining unit 31 by a hard decoding method. The decoding unit 32 is a main functional module in the device for decoding the video data.

The decoding unit 32 can be further configured to, when receive response information indicating that decoding of data of one or more of the multiple channels of videos fails, decode the data of the one or more of channels of videos by a soft decoding method. Specifically, the decoding unit 32 can include two decoding functional modules, i.e., a hard decoding functional module and a soft decoding functional module. When the hard decoding method needs to be used to perform decoding, the hard decoding functional module is called; when the soft decoding method needs to be used to perform decoding, the soft decoding functional module is called.

The playing unit 33 can be configured to play the decoded data of the multiple channels of videos. The playing unit 33 is a main functional module in the device for playing the video data.

It should be noted that corresponding descriptions made in connection with FIG. 1 also apply to the functional units in the device for playing videos provided by embodiments of the present disclosure and thus repeated descriptions are omitted here. In embodiments of the present disclosure, related functional modules can be realized by hardware processors.

In the device for playing videos provided by embodiments of the present disclosure, after data of multiple channels of videos which needs to be played currently is obtained, the data of the multiple channels of videos is decoded by a hard decoding method firstly; when response information indicating that decoding of data of one or more of the multiple channels of videos fails is received, the data of the one or more of channels of videos is decoded by a soft decoding method. In this way, the decoding of the data of one or more channels of videos which cannot be decoded by the hard decoding method can be switched to the soft decoding method so as to play the video data. As compared with prior arts, the present disclosure can decode the data of multiple channels of videos by a combination of the hard decoding and the soft decoding, and thus the playing effect of videos can be improved and the load born by the CPU can be reduced. Also, when the decoding of the video data by the hard decoding method fails, the decoding of the video data can be automatically switched to the soft decoding to decode and play videos, and thus failures of playing of video data can be avoided. The present disclosure can decode and play video data using the hard decoding method as much as possible for different terminal devices.

Further, embodiments of the present disclosure provide another device for playing videos to implement the method described in connection with FIG. 2. As shown in FIG. 4, the device can include an obtaining unit 41, a decoding unit 42 and a playing unit 43.

The obtaining unit 41 can be configured to obtain data of multiple channels of videos which needs to be played currently. The obtaining unit 41 can obtain the data of multiple channels of videos from a video source server in which data of the multiple channels of videos which needs to be played currently are included.

The decoding unit 42 can be configured to decode the data of the multiple channels of videos obtained in the obtaining unit 41 by a hard decoding method. The decoding unit 42 is a main functional module in the device for decoding the video data.

The decoding unit 42 can be further configured to, when receive response information indicating that decoding of data of one or more of the multiple channels of videos fails, decode the data of the one or more of channels of videos by a soft decoding method. Specifically, the decoding unit 32 can include two decoding functional modules, i.e., a hard decoding functional module and a soft decoding functional module. When the hard decoding method needs to be used to perform decoding, the hard decoding functional module is called; when the soft decoding method needs to be used to perform decoding, the soft decoding functional module is called.

The playing unit 43 can be configured to play the decoded data of the multiple channels of videos. The playing unit 43 is a main functional module in the device for playing the video data.

Specifically, the decoding unit 43 is configured to, by a preset hard decoding interface function, extract the data of the multiple channels of videos into corresponding preset hard decoders to perform decoding.

The decoding unit 42 is further configured to, when receive the response information indicating that the decoding of the data of one or more of the multiple channels of videos fails, by a preset soft decoding interface function, extract the data of the one or more channels of videos into corresponding preset soft decoders to perform decoding.

Further, the device further includes an outputting unit 44.

The outputting unit 44 is configured to output notification information to indicate that the data of the one or more channels of videos are decoded by the soft decoding method.

Further, the device further includes a calculation unit 45.

The calculation unit 45 is configured to, among the multiple channels of videos, calculate the number of the channels of videos which are currently decoded by the hard decoding method.

The playing unit 43 is configured to play the decoded data of the multiple channels of videos, and display the number of the channels of videos which are currently decoded by the hard decoding method.

The playing unit 43 is further configured to, when receive an instruction from a user which instructs to switch the decoding of data of one channel of video, which is selected by the user from the one or more channels of videos which are currently decoded by the soft decoding method, from the soft decoding method to the hard decoding method, use the soft decoding method to decode data of one of the one or more channels of videos which are currently decoded by the hard decoding method, and use the hard decoding method to decode the data of the one channel of video which is selected by the user.

It should be noted that corresponding descriptions made in connection with FIG. 2 also apply to the functional units in the device for playing videos provided by embodiments of the present disclosure and thus repeated descriptions are omitted here. In embodiments of the present disclosure, related functional modules can be realized by hardware processors.

In the device for playing videos provided by embodiments of the present disclosure, after data of multiple channels of videos which needs to be played currently is obtained, the data of the multiple channels of videos is decoded by a hard decoding method firstly; when response information indicating that decoding of data of one or more of the multiple channels of videos fails is received, the data of the one or more of channels of videos is decoded by a soft decoding method. In this way, the decoding of the data of one or more channels of videos which cannot be decoded by the hard decoding method can be switched to the soft decoding method so as to play the video data. As compared with prior arts, the present disclosure can decode the data of multiple channels of videos by a combination of the hard decoding and the soft decoding, and thus the playing effect of videos can be improved and the load born by the CPU can be reduced. Also, when the decoding of the video data by the hard decoding method fails, the decoding of the video data can be automatically switched to the soft decoding to decode and play videos, and thus failures of playing of video data can be avoided. The present disclosure can decode and play video data using the hard decoding method as much as possible for different terminal devices.

Further, an embodiment of the present disclosure further provides a non-transitory computer-readable storage medium storing executable instructions, which can be executed by an electronic device to perform any methods for playing videos mentioned by embodiments of the present disclosure.

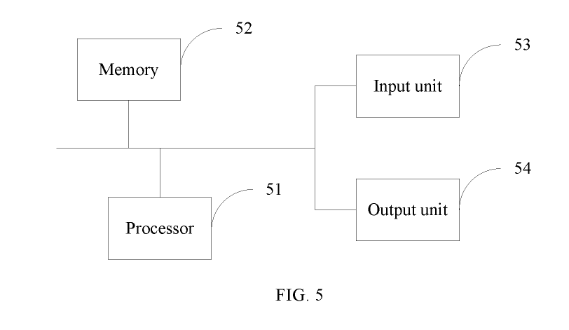

FIG. 5 is a block diagram of an electronic device which is configured to perform the methods for playing videos according to an embodiment of the present disclosure. As shown in FIG. 5, the device includes:

one or more processors 51 and memory 52. A processor 51 is showed in FIG. 5 for an example.

Device which is configured to perform the methods for playing videos can also include: input unit 53 and output unit 54.

Processor 51, memory 52, input unit 53 and output unit 54 can be connected by BUS or other methods, and BUS connecting is showed in FIG. 5 for an example.

Memory 52 can be used for storing non-transitory software program, non-transitory computer executable program and modules as a non-transitory computer-readable storage medium, such as corresponding program instructions/modules for the methods for playing videos mentioned by embodiments of the present disclosure (such as shown in FIG. 3, obtaining unit 31, decoding unit 32 and playing unit 33). Processor 51 performs kinds of functions and playing videos of the electronic device by executing non-transitory software program, instructions and modules which are stored in memory 52, thereby realizes the methods for playing videos mentioned by embodiments of the present disclosure.

Memory 52 can include program storage area and data storage area, thereby the operating system and applications required by at least one function can be stored in program storage area and data created by using the device for playing videos can be stored in data storage area. Furthermore, memory 52 can include high speed Random-access memory (RAM) or non-volatile memory such as magnetic disk storage device, flash memory device or other non-volatile solid state storage devices. In some embodiments, memory 52 can include long-distance setup memories relative to processor 51, which can communicate with the device for playing videos by networks. The examples of said networks are including but not limited to Internet, Intranet, LAN, mobile Internet and their combinations.

Input unit 53 can be used to receive inputted number, character information and key signals causing user configures and function controls of the device for playing videos. Output unit 54 can include a display screen or a display device.

The said module or modules are stored in memory 52 and perform the methods for playing videos when executed by one or more processors 51.

The said device can reach the corresponding advantages by including the function modules or performing the methods provided by embodiments of the present disclosure. Those methods can be referenced for technical details which may not be completely described in this embodiment.

Electronic devices in embodiments of the present disclosure can be existences with different types, which are including but not limited to:

(1) Mobile Internet devices: devices with mobile communication functions and providing voice or data communication services, which include smartphones (e.g. iPhone), multimedia phones, feature phones and low-cost phones.

(2) Super mobile personal computing devices: devices belong to category of personal computers but mobile internet function is provided, which include PAD, MID and UMPC devices, e.g. iPad.

(3) Portable recreational devices: devices with multimedia displaying or playing functions, which include audio or video players, handheld game players, e-book readers, intelligent toys and vehicle navigation devices.

(4) Servers: devices with computing functions, which are constructed by processors, hard disks, memories, system BUS, etc. For providing services with high reliabilities, servers always have higher requirements in processing ability, stability, reliability, security, expandability, manageability, etc., although they have a similar architecture with common computers.

(5) Other electronic devices with data interacting functions.

The embodiments of devices are described above only for illustrative purposes. Units described as separated portions may be or may not be physically separated, and the portions shown as respective units may be or may not be physical units, i.e., the portions may be located at one place, or may be distributed over a plurality of network units. A part or whole of the modules may be selected to realize the objectives of the embodiments of the present disclosure according to actual requirements.

In view of the above descriptions of embodiments, those skilled in this art can well understand that the embodiments can be realized by software plus necessary hardware platform, or may be realized by hardware. Based on such understanding, it can be seen that the essence of the technical solutions in the present disclosure (that is, the part making contributions over prior arts) may be embodied as software products. The computer software products may be stored in a computer readable storage medium including instructions, such as ROM/RAM, a magnetic disk, an optical disk, to enable a computer device (for example, a personal computer, a server or a network device, and so on) to perform the methods of all or a part of the embodiments.

It shall be noted that the above embodiments are disclosed to explain technical solutions of the present disclosure, but not for limiting purposes. While the present disclosure has been described in detail with reference to the above embodiments, those skilled in this art shall understand that the technical solutions in the above embodiments can be modified, or a part of technical features can be equivalently substituted, and such modifications or substitutions will not make the essence of the technical solutions depart from the spirit or scope of the technical solutions of various embodiments in the present disclosure.

What is claimed is:

1. A method for playing videos, implemented by a terminal, comprising:
obtaining data of multiple channels of videos which needs to be played currently;
decoding the data of the multiple channels of videos by a hard decoding method;
when receiving response information indicating that decoding of data of one or more of the multiple channels of videos fails, decoding the data of the one or more of channels of videos by a soft decoding method; and
playing the decoded data of the multiple channels of videos.

2. The method for playing videos according to claim 1, wherein the decoding of the data of the multiple channels of videos by the hard decoding method comprises:
by a preset hard decoding interface function, extracting the data of the multiple channels of videos into corresponding preset hard decoders to perform decoding; and
the decoding of the data of the one or more of channels of videos by the soft decoding method when receiving the response information indicating that the decoding of the data of one or more of the multiple channels of videos fails, comprises:
when receiving the response information indicating that the decoding of the data of one or more of the multiple channels of videos fails, by a preset soft decoding interface function, extracting the data of the one or more channels of videos into corresponding preset soft decoders to perform decoding.

3. The method for playing videos according to claim 1, wherein after decoding of the data of the one or more of channels of videos by the soft decoding method when receiving the response information indicating that the decoding of the data of one or more of the multiple channels of videos fails, the method further comprises:
outputting notification information to indicate that the data of the one or more channels of videos are decoded by the soft decoding method.

4. The method for playing videos according to claim 1, wherein before the playing of the decoded data of the multiple channels of videos, the method further comprises:
among the multiple channels of videos, calculating the number of the channels of videos which are currently decoded by the hard decoding method; and
the playing of the decoded data of the multiple channels of videos, comprises:
playing the decoded data of the multiple channels of videos, and displaying the number of the channels of videos which are currently decoded by the hard decoding method.

5. The method for playing videos according to claim 1, wherein after the playing of the decoded data of the multiple channels of videos, the method further comprises:
when receiving an instruction from a user which instructs to switch the decoding of data of one channel of video, which is selected by the user from the one or more channels of videos which are currently decoded by the soft decoding method, from the soft decoding method to the hard decoding method, using the soft decoding method to decode and play data of one of the one or more channels of videos which are currently decoded by the hard decoding method, and using the hard decoding method to decode and play the data of the one channel of video which is selected by the user.

6. A non-transitory computer-readable storage medium storing executable instructions, wherein the executable instructions are configured to:
obtain data of multiple channels of videos which needs to be played currently;
decode the data of the multiple channels of videos by a hard decoding method;
when receiving response information indicating that decoding of data of one or more of the multiple channels of videos fails, decode the data of the one or more of channels of videos by a soft decoding method; and
play the decoded data of the multiple channels of videos.

7. The non-transitory computer-readable storage medium according to claim 6, wherein the decoding of the data of the multiple channels of videos by the hard decoding method comprises:
by a preset hard decoding interface function, extracting the data of the multiple channels of videos into corresponding preset hard decoders to perform decoding; and
the decoding of the data of the one or more of channels of videos by the soft decoding method when receiving the response information indicating that the decoding of the data of one or more of the multiple channels of videos fails, comprises:
when receiving the response information indicating that the decoding of the data of one or more of the multiple channels of videos fails, by a preset soft decoding interface function, extracting the data of the one or more channels of videos into corresponding preset soft decoders to perform decoding.

8. The non-transitory computer-readable storage medium according to claim 6, wherein after decoding of the data of the one or more of channels of videos by the soft decoding method when receiving the response information indicating that the decoding of the data of one or more of the multiple channels of videos fails, the executable instructions are further configured to:
output notification information to indicate that the data of the one or more channels of videos are decoded by the soft decoding method.

9. The non-transitory computer-readable storage medium according to claim 6, wherein before the playing of the decoded data of the multiple channels of videos, the executable instructions are further configured to:
among the multiple channels of videos, calculate the number of the channels of videos which are currently decoded by the hard decoding method; and
the playing of the decoded data of the multiple channels of videos, comprises:
playing the decoded data of the multiple channels of videos, and displaying the number of the channels of videos which are currently decoded by the hard decoding method.

10. The non-transitory computer-readable storage medium according to claim 6, wherein after the playing of the decoded data of the multiple channels of videos, the executable instructions are further configured to:
when receiving an instruction from a user which instructs to switch the decoding of data of one channel of video, which is selected by the user from the one or more channels of videos which are currently decoded by the soft decoding method, from the soft decoding method to the hard decoding method, use the soft decoding method to decode and play data of one of the one or more channels of videos which are currently decoded by the hard decoding method, and use the hard decoding method to decode and play the data of the one channel of video which is selected by the user.

11. An electronic device, comprising:
at least one processor; and
a memory communicably connected with the at least one processor for storing instructions executable by the at least one processor, wherein execution of the instructions by the at least one processor causes the at least one processor to:
obtain data of multiple channels of videos which needs to be played currently;
decode the data of the multiple channels of videos by a hard decoding method;
when receiving response information indicating that decoding of data of one or more of the multiple channels of videos fails, decode the data of the one or more of channels of videos by a soft decoding method; and
play the decoded data of the multiple channels of videos.

12. The electronic device according to claim 11, wherein the decoding of the data of the multiple channels of videos by the hard decoding method comprises:
by a preset hard decoding interface function, extracting the data of the multiple channels of videos into corresponding preset hard decoders to perform decoding; and
the decoding of the data of the one or more of channels of videos by the soft decoding method when receiving the response information indicating that the decoding of the data of one or more of the multiple channels of videos fails, comprises:
when receiving the response information indicating that the decoding of the data of one or more of the multiple channels of videos fails, by a preset soft decoding interface function, extracting the data of the one or more channels of videos into corresponding preset soft decoders to perform decoding.

13. The electronic device according to claim 11, wherein after decoding of the data of the one or more of channels of videos by the soft decoding method when receiving the response information indicating that the decoding of the data of one or more of the multiple channels of videos fails, the instructions are executed to cause the at least one processor to:
output notification information to indicate that the data of the one or more channels of videos are decoded by the soft decoding method.

14. The electronic device according to claim 11, wherein before the playing of the decoded data of the multiple channels of videos, the instructions are executed to cause the at least one processor to:
among the multiple channels of videos, calculate the number of the channels of videos which are currently decoded by the hard decoding method; and
the playing of the decoded data of the multiple channels of videos, comprises:
playing the decoded data of the multiple channels of videos, and displaying the number of the channels of videos which are currently decoded by the hard decoding method.

15. The electronic device according to claim 11, wherein after the playing of the decoded data of the multiple channels of videos, the instructions are executed to cause the at least one processor to:
when receiving an instruction from a user which instructs to switch the decoding of data of one channel of video, which is selected by the user from the one or more channels of videos which are currently decoded by the soft decoding method, from the soft decoding method to the hard decoding method, use the soft decoding method to decode and play data of one of the one or more channels of videos which are currently decoded by the hard decoding method, and use the hard decoding method to decode and play the data of the one channel of video which is selected by the user.
